(19) United States
(12) Patent Application Publication
(10) Pub. No.: US 2024/0126951 A1
(43) Pub. Date: Apr. 18, 2024

(54) MACHINE LEARNING-BASED TIMESTEP SELECTION FOR ITERATIVE NUMERICAL SOLVERS

(71) Applicant: SAUDI ARABIAN OIL COMPANY, Dhahran (SA)

(72) Inventors: Fatimah A. Al-Ruwai, Dhahran (SA); Majdi A. Baddourah, Dhahran (SA); Osaid F. Hajjar, Dhahran (SA); Ali Al-Turki, Dhahran (SA)

(73) Assignee: SAUDI ARABIAN OIL COMPANY, Dhahran (SA)

(21) Appl. No.: 18/046,047

(22) Filed: Oct. 12, 2022

(51) Int. Cl. G06F 30/27; G06F 30/28

(52) U.S. Cl. CPC G06F 30/27; G06F 30/28; G06F 2111/10

(57) ABSTRACT

A method for accelerating numerical solution of a differential equation representing fluid flow in porous media associated with hydrocarbon well environments involves obtaining input data associated with a previous timestep of a numerical solver operating on the differential equation, predicting, by a machine learning model, a current timestep size for the numerical solver from the previous timestep to a current timestep immediately following the previous timestep, and executing the numerical solver using the current timestep size on the differential equation to generate a simulation output for the current timestep.

### BACKGROUND

Differential equations and partial differential equations (PDEs) are commonly used to represent and simulate systems. For example, in the oil and gas industry, fluid flow in porous media is simulated by solving PDEs. To solve partial differential equations, iterative methods (e.g., the Newton Method) may be used. Such iterative methods require the selection of a timestep size (delta time) to converge to an acceptable solution. Starting with an initial guess of a timestep size, the numerical solver tries to solve the PDE or system of PDEs. If the solver fails to converge to a solution, the timestep size will be reduced and the solver will attempt again to find a solution. This process is repeated until an acceptable solution is found.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for accelerating numerical solution of a differential equation representing fluid flow in porous media associated with hydrocarbon well environments, the method comprising: obtaining input data associated with a previous timestep of a numerical solver operating on the differential equation; predicting, by a machine learning model, a current timestep size for the numerical solver from the previous timestep to a current timestep immediately following the previous timestep; and executing the numerical solver using the current timestep size on the differential equation to generate a simulation output for the current timestep.

In general, in one aspect, embodiments relate to a system comprising: a plurality of computing systems configured to perform operations comprising: obtaining input data associated with a previous timestep of a numerical solver operating on a differential equation; predicting, by a machine learning model, a current timestep size for the numerical solver from the previous timestep to a current timestep immediately following the previous timestep; and executing the numerical solver using the current timestep size on the differential equation to generate a simulation output for the current timestep.

In light of the structure and functions described above, embodiments of the disclosure may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a well environment in accordance with one or more embodiments.

FIG. 2 shows a simulation system in accordance with one or more embodiments.

FIG. 3 shows a flowchart for a method in accordance with one or more embodiments.

FIG. 4 shows a flowchart for a method in accordance with one or more embodiments.

FIGS. 5A, 5B, 5C, 5D1, 5D2, 5E, and 5F show example implementations of methods in accordance with one or more embodiments.

FIG. 6 shows performance results associated with implementations of embodiments of the disclosure.

FIG. 7 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for machine learning-based timestamp selection for iterative numerical solvers. Differential equations and partial differential equations (PDEs) are commonly used to represent and simulate systems. To solve differential equations/partial differential equations, iterative methods (e.g., the Newton Method) may be used. Such iterative methods require the selection of a timestep size (delta time) to converge to an acceptable solution. Starting with an initial guess of a timestep size, the numerical solver tries to solve the system of differential equations/PDEs. If the solver fails to converge to a solution, the timestep size is reduced, and the solver attempts again to find a solution. This process is repeated until an acceptable solution is found.

Embodiments of the disclosure use Artificial Neural Networks (ANN) to predict the timestep size that ensures successful convergence of the numerical solver. The ANN model may be trained and validated using datasets that cover a wide range of the solver behavior and convergence information. In one or more embodiments, the training process of the ANN is an iterative approach, where the input is presented to the ANN and the output is generated based on the activation functions and the weights. The iterations may continue until a threshold is met. Once training is completed, the ANN may be ready to predict the timestep size for that set of PDEs.

As further illustrated below, in reservoir simulation, for instance, the ANN coupling with the numerical solver, was able to predict the optimal timestep size with an accuracy of 90%. This significantly reduced the simulation runtime and improved the numerical stability and convergence, which positively reflected on reservoir simulation key performance indicators (e.g., high performance computing effectiveness). Also, the results show that using the described coupling of an ANN and a numerical solver allows for a speed up of reservoir simulation runtime by, for example, at least 20%.

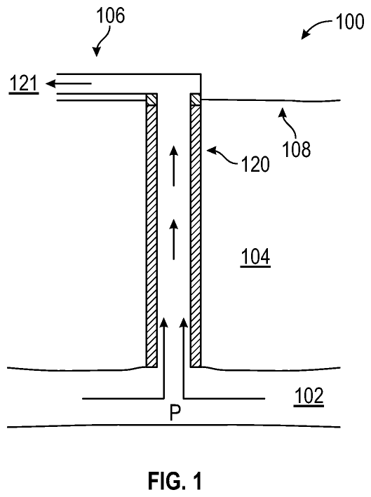

FIG. 1 shows a schematic diagram in accordance with one or more embodiments. FIG. 1 illustrates a well environment (100) that includes a hydrocarbon reservoir (“reservoir”) (102) located in a subsurface hydrocarbon-bearing formation (104) and a well system (106). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, and resistivity. In the case of the well system (106) being operated as a production well, the well system (106) may facilitate the extraction of hydrocarbons (or “production”) from the reservoir (102).

In some embodiments, the well system (106) includes a wellbore (120). The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “downhole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

While FIG. 1 shows various configurations of hardware components and/or software components, other configurations may be used without departing from the scope of the disclosure. For example, various components in FIG. 1 may be combined to create a single component. As another example, the functionality performed by a single component may be performed by two or more components.

Various aspects of the well environment (100) and many other systems may be simulated using PDEs. The subsequently described methods may be used to numerically solve these PDEs, in accordance with embodiments of the disclosure.

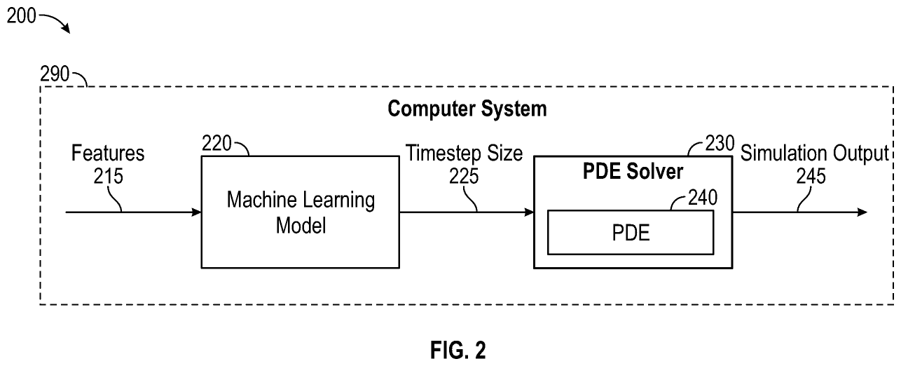

FIG. 2 shows a schematic diagram of a simulation system, in accordance with one or more embodiments. The simulation system (200) includes a partial differential equation (PDE) solver (230) for solving the PDE (240). A timestep size (225) for the iterative solving of the PDE is provided as an input to the PDE solver (230). The PDE solver (230) may have additional inputs, as further discussed below. The output of the PDE solver (230) is the simulation output (245). In one or more embodiments, the timestep size (225) is determined by a machine learning model (220), based on features (215). Each of these elements is subsequently discussed. The machine learning model (220) and the PDE solver (230) may be executed on one or more computer systems (290). Specific implementations are discussed below.

In one or more embodiments, the simulation system (200) is used for reservoir simulation using differential equations, including PDEs. Finite-difference methods are commonly used in reservoir simulation to solve fluid flow equations. These equations are discretized in both time and space to be solved iteratively. The discretization in time (i.e., timestep) varies throughout the simulation run, and is governed by the solver having to converge to an acceptable solution of the fluid flow PDEs. Reservoir models also vary in complexity, which might cause slow solver convergence with large numbers of iterations and timestep cuts. Such convergence issues may cause a significant increase in simulation runtime and inefficient compute resources utilization.

Various solvers exist for iteratively solving differential equations. The Newton method is one such method. The Newton method uses an iterative approach using optimized step sizes to iteratively solve the differential equation. The selection of the step size plays a significant role in obtaining a solution. If an overly large step size is selected, valuable information may be lost or ignored. If an overly small step size is selected, the solving of the differential equation may be unnecessarily slowed down. In one or more embodiments, an optimization is performed to identify the optimal timestep size for the solution of the differential equation.

In one or more embodiments, the machine learning model (220) predicts the optimal timestep size to ensure successful solver convergence while minimizing execution time. In one embodiment, an Artificial Neural Network (ANN) is used to predict the timestep size (225). Subsequently, the PDE solver (230) may perform an iteration on the PDE (240) to produce a simulation output (245). Methods performed by the simulations system (200) to produce the simulation output (245) are subsequently described.

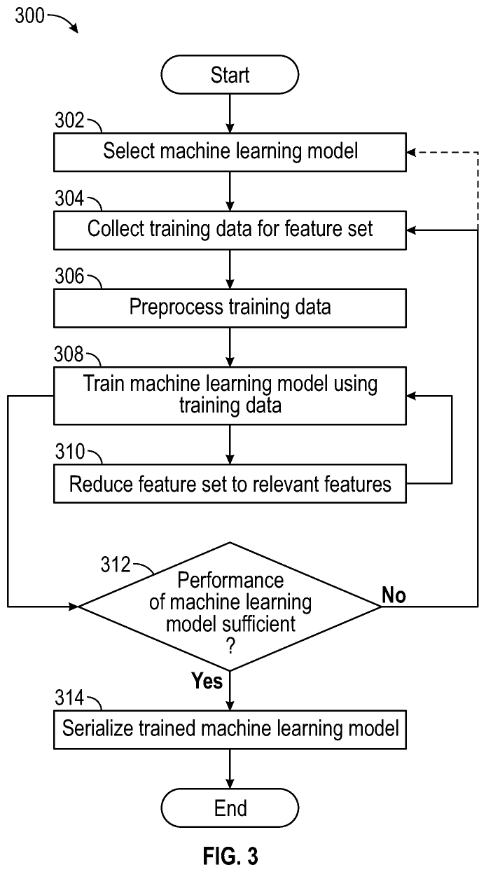

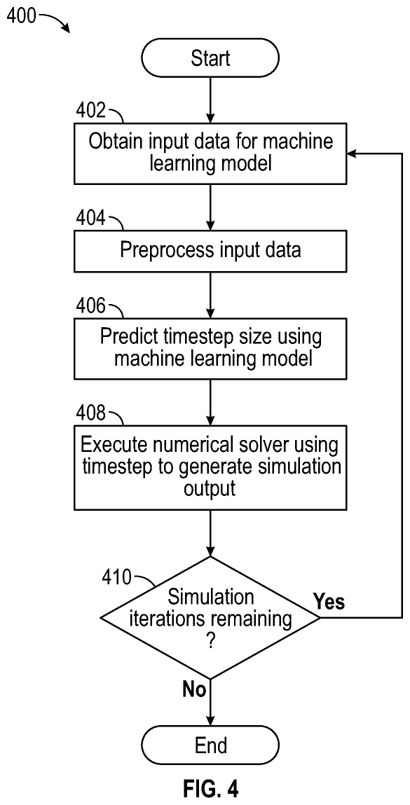

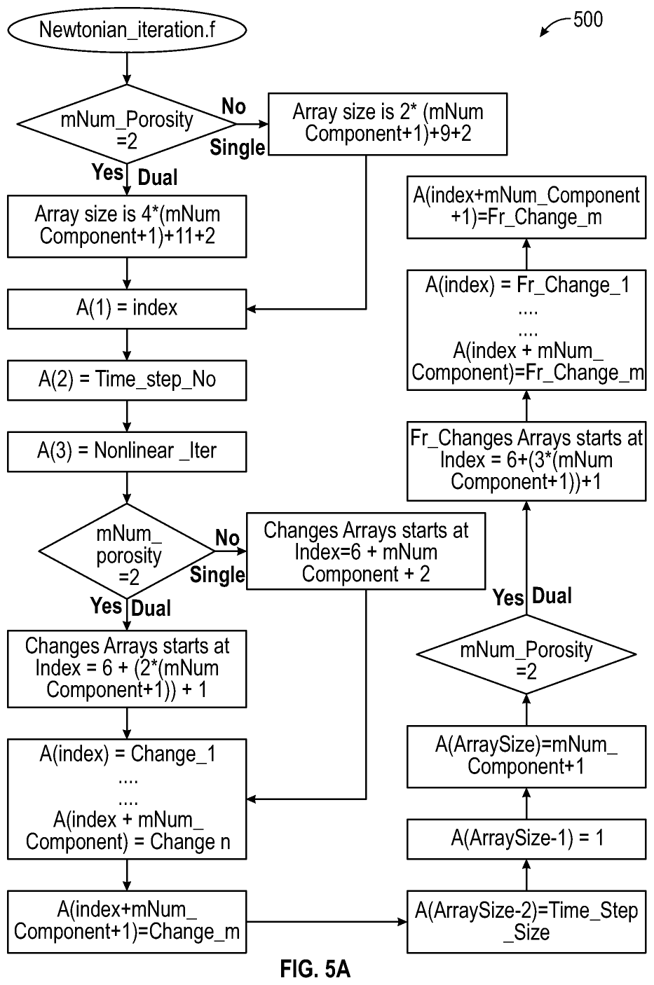

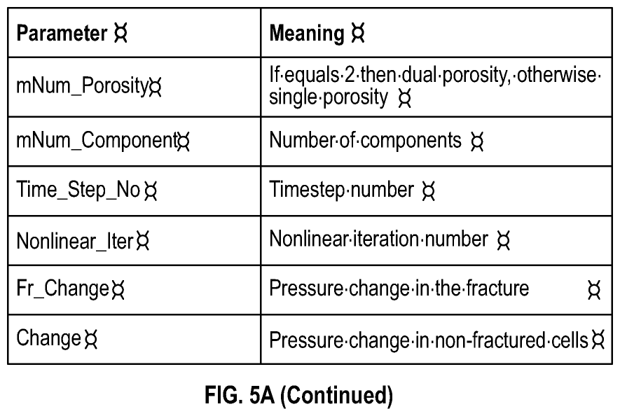

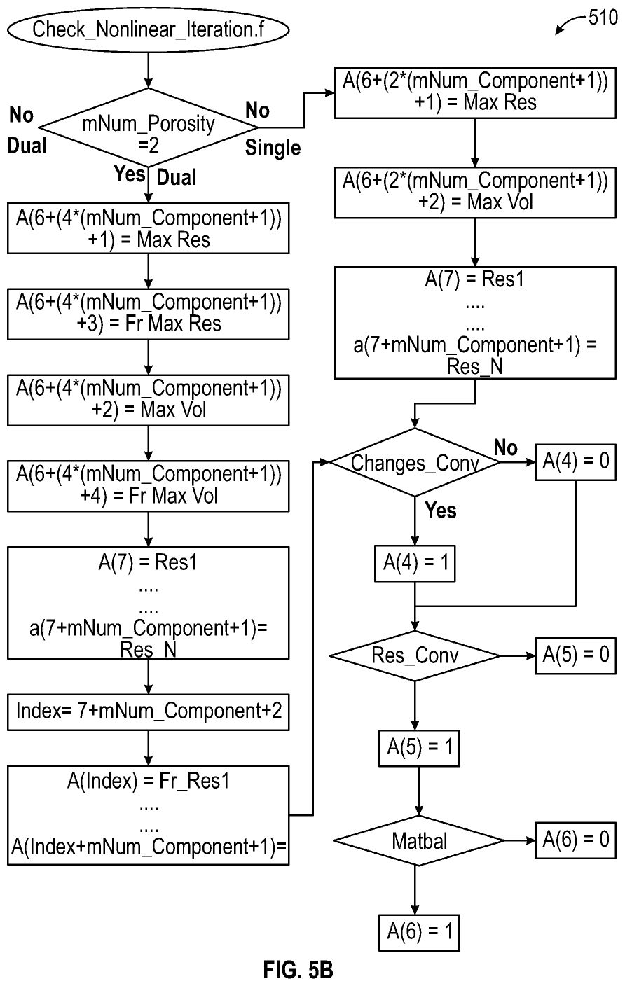

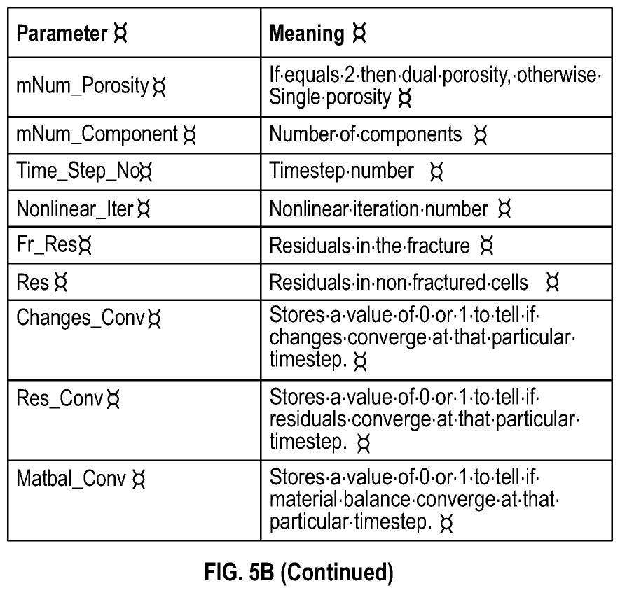

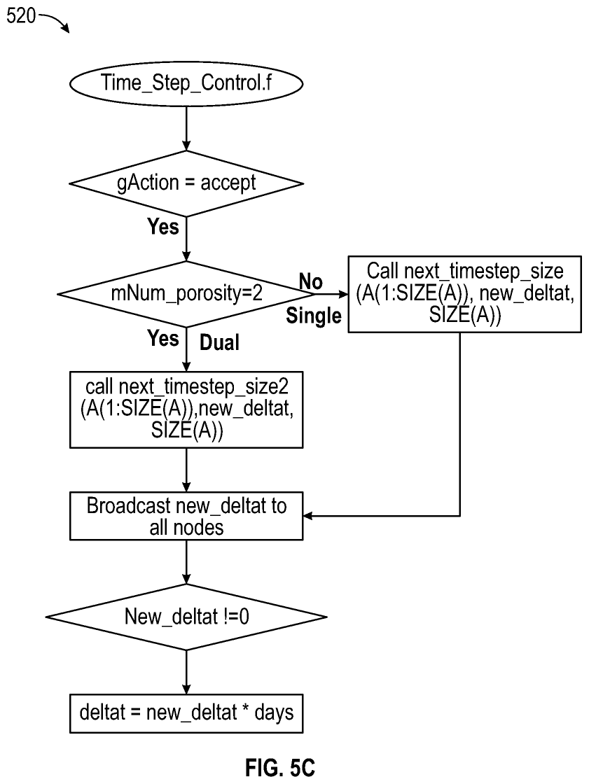

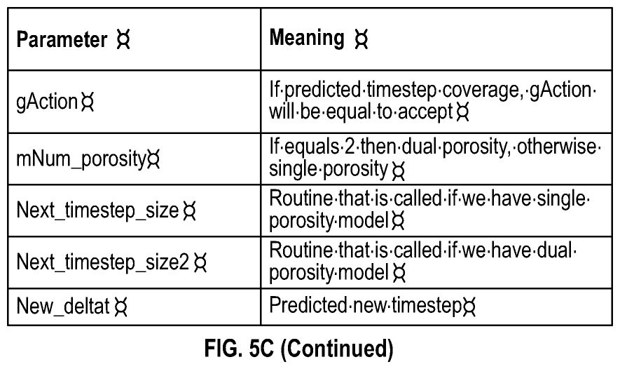

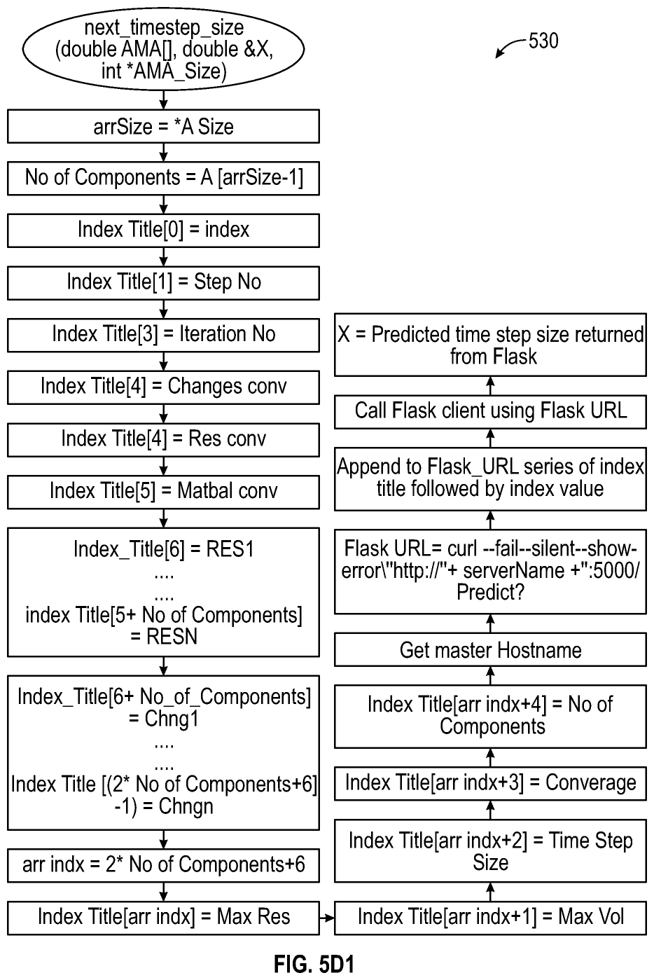

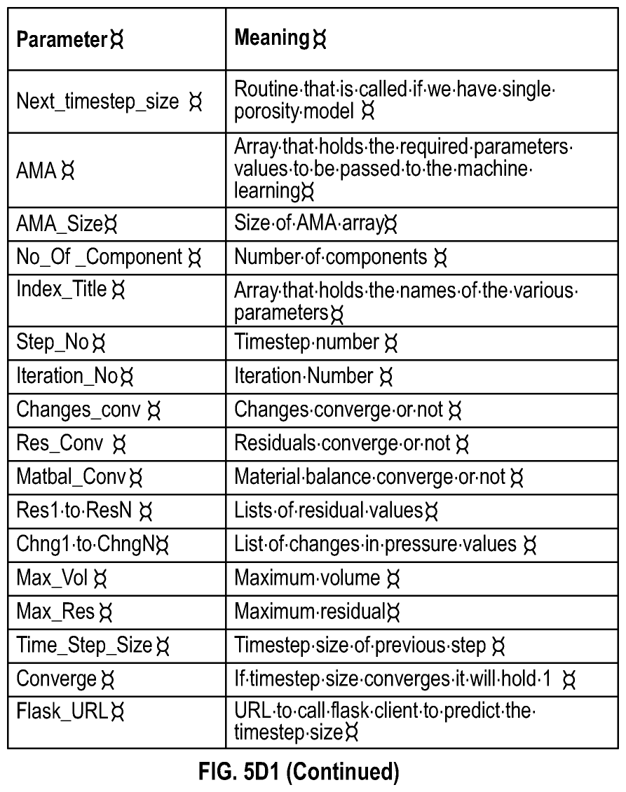

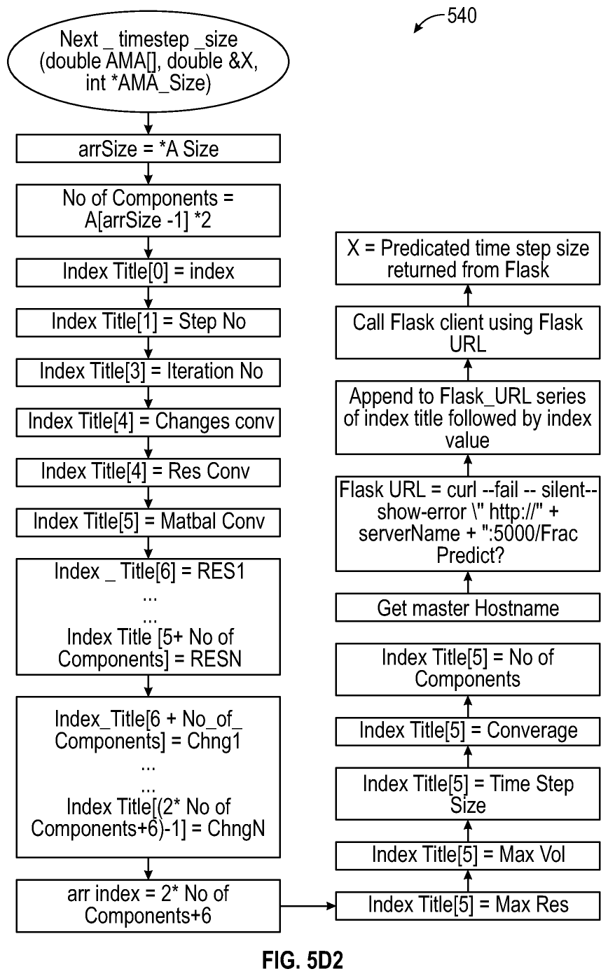

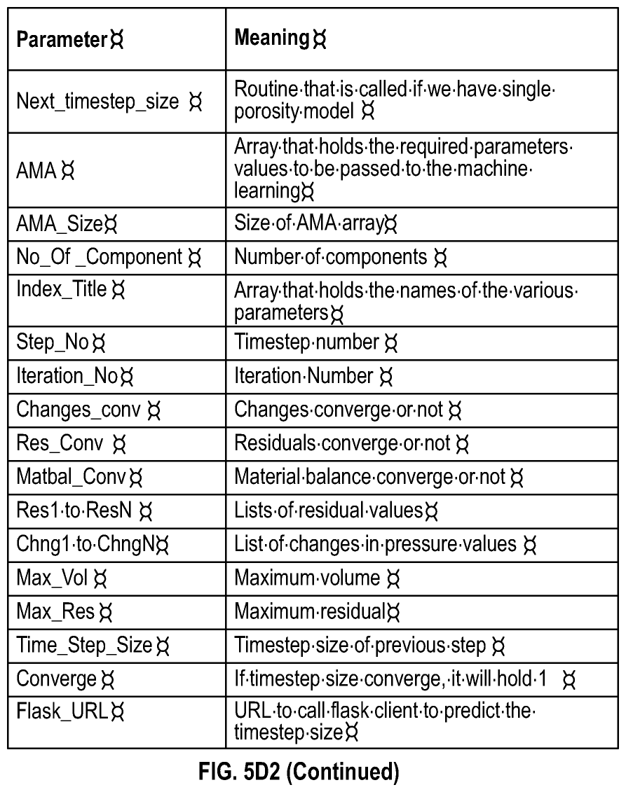

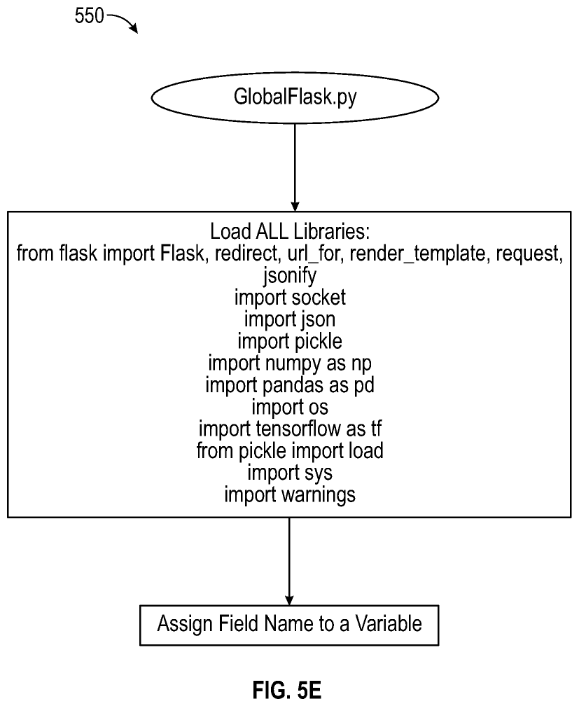

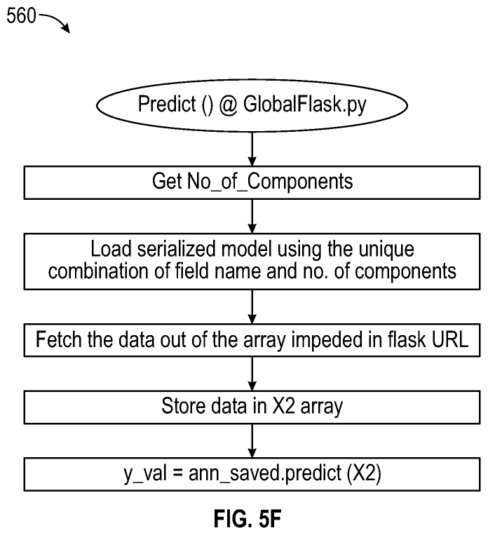

FIGS. 3 and 4 show flowcharts in accordance with one or more embodiments. FIG. 3 shows operations performed to train the machine learning model (220), and FIG. 4 shows operations performed to solve a differential equation or PDE in accordance with embodiments of the disclosure. Specific example implementations are described below in reference to FIGS. 5A, 5B, 5D1, 5D2, 5E, and 5F.

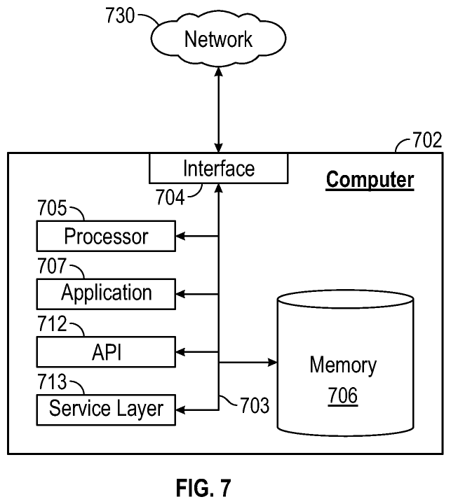

One or more steps in FIGS. 3 and 4 may be performed by one or more components introduced in FIG. 2, and/or on a computer system, e.g., as shown in FIG. 7. While the various steps in FIGS. 3 and 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Broadly speaking, the methods of FIGS. 3 and 4 involve multiple operations. First, suitable features for the prediction of the timesteps may be identified. Further, a suitable machine learning model for the prediction of the timesteps may be selected. Then, data may be collected and analyzed in order to identify the relevant or influential set of features, which can be key to the solver convergence. Less influential or relevant features may be discarded. A suitable machine learning model may also be selected. A training of the machine learning model is performed, once the suitable machine learning model and the relevant features have been identified. Eventually, the trained machine learning model is used to predict a timestep, and the PDE solver operates on the PDE using the timestep.

Turning to FIG. 3, a method (300) for training a machine learning model to predict timestep size, in accordance with one or more embodiments, is shown.

In Step 300, a machine learning model is selected for the prediction of the timestep size. The machine learning model may be selected from many different machine learning models.

The machine learning model may be based on any type of machine learning technique. For example, perceptrons, artificial neural networks (ANNs) convolutional neural networks (CNNs), deep neural networks (DNNs), recurrent neural networks (RNNs), support vector machines, decision trees, inductive learning models, deductive learning models, reinforcement learning models, etc. may be used. In some embodiments, two or more different types of machine-learning models are integrated into a single machine-learning architecture, e.g., a machine-learning model may include support vector machines and neural networks.

In some embodiments, various types of machine learning algorithms, e.g., backpropagation algorithms, may be used to train the machine learning models. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the machine-learning model. In some embodiments, historical data, e.g., production data recorded over time may be augmented to generate synthetic data for training a machine learning model.

With respect to neural networks, for example, a neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the neural network. Likewise, these weighted data inputs may be summed such that this sum is communicated through a neuron's activation function to other hidden layers within the neural network. As such, the activation function may determine whether and to what extent an output of a neuron progresses to other neurons where the output may be weighted again for use as an input to the next hidden layer.

Turning to recurrent neural networks, a recurrent neural network (RNN) may perform a particular task repeatedly for multiple data elements in an input sequence (e.g., a sequence of maintenance data or inspection data), with the output of the recurrent neural network being dependent on past computations (e.g., failure to perform maintenance or address an unsafe condition may produce one or more hazard incidents). As such, a recurrent neural network may operate with a memory or hidden cell state, which provides information for use by the current cell computation with respect to the current data input. For example, a recurrent neural network may resemble a chain-like structure of RNN cells, where different types of recurrent neural networks may have different types of repeating RNN cells. Likewise, the input sequence may be time-series data, where hidden cell states may have different values at different time steps during a prediction or training operation. For example, where a deep neural network may use different parameters at each hidden layer, a recurrent neural network may have common parameters in an RNN cell, which may be performed across multiple time steps. To train a recurrent neural network, a supervised learning algorithm such as a backpropagation algorithm may also be used. In some embodiments, the backpropagation algorithm is a backpropagation through time (BPTT) algorithm. Likewise, a BPTT algorithm may determine gradients to update various hidden layers and neurons within a recurrent neural network in a similar manner as used to train various deep neural networks. In some embodiments, a recurrent neural network is trained using a reinforcement learning algorithm such as a deep reinforcement learning algorithm. For more information on reinforcement learning algorithms, see the discussion below.

Embodiments are contemplated with different types of RNNs. For example, classic RNNs, long short-term memory (LSTM) networks, a gated recurrent unit (GRU), a stacked LSTM that includes multiple hidden LSTM layers (i.e., each LSTM layer includes multiple RNN cells), recurrent neural networks with attention (i.e., the machine-learning model may focus attention on specific elements in an input sequence), bidirectional recurrent neural networks (e.g., a machine-learning model that may be trained in both time directions simultaneously, with separate hidden layers, such as forward layers and backward layers), as well as multidimensional LSTM networks, graph recurrent neural networks, grid recurrent neural networks, etc., may be used. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition.

In some embodiments, one or more ensemble learning methods may be used in connection to the machine-learning models. For example, an ensemble learning method may use multiple types of machine-learning models to obtain better predictive performance than available with a single machine-learning model. In some embodiments, for example, an ensemble architecture may combine multiple base models to produce a single machine-learning model. One example of an ensemble learning method is a BAGGing model (i.e., BAGGing refers to a model that performs Bootstrapping and Aggregation operations) that combines predictions from multiple neural networks to add a bias that reduces variance of a single trained neural network model. Another ensemble learning method includes a stacking method, which may involve fitting many different model types on the same data and using another machine-learning model to combine various predictions.

The selection of the machine learning model in Step 300 may involve selecting the machine learning model with the best performance based on the training of the method (300). The machine learning model with the best performance may be identified through repeated execution of steps of the method (300) using different machine learning models, until the best-performing machine learning model is identified. In one embodiment of the disclosure, an ANN is selected. In one embodiment, a multilayer feed-forward artificial neural network is used in combination with a backpropagation algorithm. The Adam optimization algorithm may be used to update network weights iteratively based on training data. After selection of a particular type of machine learning model, the hyperparameters of the machine learning model may be selected. In the example of an ANN, the hyperparameters may include the number of layers, the number of neurons per layer, the activation functions of neurons, etc. In some embodiments, relu and tan h activation functions are used.

In Step 304, training data are collected for a feature set. Initially, the features to be included in the feature set may not be known. Accordingly, the initial feature set may include many features including less relevant features, i.e., features that are not necessarily particularly beneficial for the purpose of predicting a timestep size. A set of features for the prediction of a timestep size for a fluid flow simulation is provided below in Table 1.

TABLE 1
Selected Features for the Machine Learning Model

| Parameter | Description |
|---|---|
| Index | Integer number represents timestep Number |
| Step No | Double precision number represents timestep size |
| Iteration | Iteration number |
| No | |
| Changes | Either solution change is less than user specified |
| Conv | threshold (Yes: 1, No: 0) |
| Res Conv | Either solution residual is less than user specified |
| | threshold (Yes: 1, No: 0) |
| Matbal | Either material balance error is less than user specified |
| Conv | threshold (Yes: 1, No: 0) |
| Res(1 − N) | Array of residuals values |
| Chng(1 − N) | Array of solution changes values |
| Max_Res | Maximum residual |
| Max_Vol | Water saturation residual Maximum Volume |
| Fr_Max_Res | Fracture maximum residual |
| Fr_Max Vol | Fracture maximum Volume |
| TSS | Previous timestep size |
| Converge | Converged or Failed (C: converged, F: failed) |

Embodiments of the disclosure are not limited to the features shown in Table 1. In one example, data for the features of Table 1 are collected from a previously performed simulation of the fluid flow simulation. Some of the features may include data from an oil or gas field, whereas some of the features are a result of a previous simulation of the fluid flow for the oil or gas field (e.g., previous timestep size, residuals, etc.). The features presented in this table of the previous timestep have strong relation with the next time step size, i.e., the timestep size to be predicted. In other words, these features are considered relevant for the purpose of predicting a timestep size.

In one or more embodiments, the training data are specific to one particular oil or gas (hydrocarbon) field, or even a smaller region of a field. Accordingly, the machine learning model resulting from the training according to the method (300) may be specific to that field, thereby increasing accuracy of the timestep size prediction. A different machine learning model may be trained for a different field. Limiting the machine learning model to a specific field (with specific physics that may be different from the physics of other fields) may result in better accuracy because of the specificity of the machine learning model which would be diluted by training the machine learning model using training data from multiple fields.

In Step 306, the training data are preprocessed. The data collected in Step 304 may be in data formats that cannot be used directly for training the machine learning model. For example, data in text format cannot be used. Accordingly, the collected data may be transformed in such manner that they are suitable for training of the machine learning model. For example, textual data may be converted to numerical data, extra spaces may be eliminated, etc. The data may further undergo data smoothing, data scaling, and/or data distribution.

The data may be scaled such that each parameter is in the same range (typically between 0 and 1) to improve the performance of the ANN. Next, the data may be split into training, testing and validation sets. Training data may subsequently be used for training the machine learning model. Validation data may be used in order to decide whether enough learning has been achieved and training may be stopped. Testing data may be used to test the performance of the machine learning model after training in order to determine determines how well the machine learning model predicts the timestep size. In one example, 70% of the data may be used as training data and 30% of the data may be used as validation data.

In Step 308, the machine learning model is trained using the machine learning model. The type of training that is used may depend on the type of machine learning model. For example, backpropagation may be used to train an ANN, as previously described.

In Step 310, the feature set may be reduced. The execution of Step 310 is optional. Initially, data for the full feature set may be considered for the training of the machine learning model in Step 308. However, a re-training of the machine learning model may later be performed with a reduced feature set. Specifically, some features may be identified as less relevant in comparison to other features, regarding their role in predicting the timestep size. Accordingly, the less relevant features may be excluded when retraining the machine learning model. In order to eliminate less relevant features, each feature in the feature set may be analyzed on its impact on the estimate produced by the machine learning model. The impact may be assessed, for example, using Shapley values. Examples of features that may be relevant include but are not limited to pressure changes, residual errors, previous timestep size, etc.

In Step 312, a test is performed to determine the performance of the trained machine learning model. The validation data may be used for the test. If a certain accuracy, e.g. at least 80%, 85%, or any other desired accuracy is achieved, the method may terminate the training and proceed with the execution of Step 314. Alternatively, if the accuracy is considered insufficient, the method may proceed by repeating either Step 302 with a different machine learning model, or by repeating Step 304 by collecting new training data.

In Step 314, the machine learning model, after the training, is serialized. The trained machine learning model may be saved in a file and may later (e.g., when executing the method of FIG. 4) get restored as needed to predict against any new input of data.

Turning to FIG. 4, a method (400) for numerically solving a differential equation using a predicted timestep size, in accordance with one or more embodiments, is shown. The method (400) may be repeatedly executed (e.g., in a loop) to solve the differential equation/partial differential equation over time, in timesteps predicted by the method (400).

In Step 402, the input data for the machine learning model are obtained. The input data, in one or more embodiments, are input data for features that were used for training the machine learning model using the method (300). For example, input data for the features as shown in Table 1 may be used. For a current timestep, with a timestep size to be predicted, at least some of the input data may come from the execution of the previous timestep, i.e., the time step immediately before the current time step. For example, the input data “TSS” of Table 1 is the previous timestep size.

In Step 404, the input data are preprocessed. The preprocessing, if needed, may be performed to obtain input data in a format similar to that obtained by the execution of Step 306. Operations similar to those of Step 306 may be used.

In Step 406, the timestep size is predicted based on the input data, processed by the machine learning model. The predicted timestep size is for a current timestep immediately following the previous timestep of the repeated execution of the method (400).

In Step 408, the numerical solver (which may be based on Newton's method) is executed using the timestep size to operate on the differential equation/partial differential equation to generate a simulation output for the current timestep. In one example, the simulation output is the numerical solution of the fluid flow differential equation at the current timestep.

In Step 410, if additional simulation iterations are remaining (i.e., a solution of the differential equation further into the future is needed or desired), the execution of the method continues with Step 402. Otherwise, the execution of the method may terminate.

Oil and gas companies utilize the numerical reservoir simulation to conduct reservoir studies, long and short-term planning, and reserves estimates. The described embodiments may be used for these reservoir simulations. Commercial or proprietary numerical reservoir simulators may be used to conduct aforementioned studies. It is a common practice that simulation post-processing applications are used where data gets visualized in 2D and/or 3D. These applications are capable of processing results from multiple simulations consisting of million of cells and thousands of wells. Engineers may view the injection and production rates of oil, gas, and water as well as pressure change over simulation time. Rates and pressure data can be visualized over different time periods (yearly, monthly, daily, hourly). In addition, reservoir modeling can be performed by creating static and dynamic models which can give spatial behavior and characteristics of reservoirs and rock fluids. Such tools can assist in providing more efficient techniques to increase hydrocarbon recovery and reduce water cut.

FIGS. 5A, 5B, 5C, 5D1, 5D2, 5E, and 5F show example implementations of methods in accordance with one or more embodiments. The method as described in FIGS. 3 and 4 may predict the optimal timestep size at each timestep with minimal convergence. The overall performance of the method may further depend on the actual implementation of the method on one or more computer systems. For example, an overhead may exist when the serialized machine learning model, generated by the execution of the method (300), is called to predict the next timestep size. This may be a result of a time-consuming loading of machine learning libraries when executing the method (400). To reduce or eliminate this overhead, the methods may be executed using a Flask server/client architecture as subsequently discussed in reference to FIGS. 5A, 5B, 5C, 5D1, 5D2, 5E, and 5F. The Flask server/client architecture enables an initial loading of the libraries on the server side and an actual prediction on the client side. An additional overhead may be a result of the communication between the simulator and Flask client at each timestep to predict the next timestep size. This overhead may be avoided by eliminating repetitive calculations on the client side. The calculation may be performed initially when the Flask client is called for the first time, and the calculated parameter values may be saved to avoid recalculation when performing future timesteps. These and other optimizations are part of the implementation subsequently discussed in reference to FIGS. 5A, 5B, 5C, 5D1, 5D2, 5E, and 5F.

Turning to FIG. 5A, an example routine for collecting and storing input data prior to execution of a Newton iteration, in accordance with one or more embodiments, is shown.

The code of the routine (500) collects and stores some of the required input data coming from the numerical solver into an array before each Newton iteration. This prepares the input data to be passed on to the Flask server eventually for timestep size prediction. First, before writing the data into the array, the array size is initialized based on the reservoir type. A dual porosity model requires a different array size than a single porosity model. Once the array size is specified, the first three indices of the array are reserved for index, timestep number and nonlinear iteration number. Next, change errors are reserved starting from a calculated index based on the model type (depending on whether it is single porosity or dual porosity). The recording of the change errors is performed using a while loop that ends based on the number of components for that specific model. Further, the last change error is recorded outside the numerical solver as it comes from a different variable. The last three input parameters that are needed are saved into the last three indices: current timestep size, convergence value, and number of components. Finally, if the model is dual porosity, the remaining change errors are stored into the array where the start and the end of array is calculated based on the number of components. A loop may be used to save all fracture change errors up to the one before the last. The last fracture change error is recorded outside the loop by using another parameter.

Turning to FIG. 5B, an example routine for storing additional input data prior to execution of the Newton iteration, in accordance with one or more embodiments, is shown.

The code of the routine (510) stores the remaining of the required input data, coming from the numerical solver, into the array. A checkup of the model type is conducted; based on the model type and number of components of the model, and the index number of maximum residuals and maximum volume are calculated. In addition, if the model is dual porosity, two more parameters are stored into the array which are Fracture Maximum Residual and Fracture Maximum Volume. Next, the residual errors are recorded where starting index is calculated again based on the model type. A loop is iterated in both cases until it reaches the number of components. As for the case of dual porosity model, another loop is conducted to record the fracture residuals. Finally, the fourth, fifth, and sixth indices are recorded to Changes Converge, Residual Converge, and Matbal Converge parameters, respectively.

Turning to FIG. 5C, an example routine for calling a routine for predicting timestep size, in accordance with one or more embodiments, is shown.

The code of routine (520) calls a C++ routine that eventually returns the predicted timestep size back to the numerical solver. First, the routine checks whether the current iteration converges or not. If it converges, a call to C++ routine is conducted; otherwise, a timestep cut is done within the numerical solver. If the timestep size converges, another check is performed to see whether the model is single porosity or dual porosity. Depending on the model type, a different C++ routine is called. In both routines, the same set of parameters, array values, and array size are passed on. The New_deltat parameter is reserved for returning its value from the machine learning package. Once the timestep size is returned, the value is broadcasted to all nodes. If the returned value is not zero, it gets multiplied by days.

Turning to FIG. 5D1, an example routine for preprocessing incoming data in preparation for predicting timestep size (single porosity), in accordance with one or more embodiments, is shown.

The code of routine (530) is executed if the model is single porosity. The C++ routine (530) may process array data originating from a Fortran file to generate a format suitable for ingestion by the Flask server. An array named Index_Title is initialized inside the routine to store the names of the indices as it is required by Flask server. Indices 1 to 5 are used for index, step number, iteration number, changes converge, residual converge, and matbal converge, respectively. Next, a loop starting from index 6 is incremented until it reaches the number of components to record residual indices titles. Another loop is executed starting from index 6, incrementing until it reaches the number of components to record changes indices titles. Next, an array index is calculated of where the array has been used by residuals and changes in order to mark the start index of the last 5 parameters which are, maximum residuals, maximum volume, timestep size, converge, and number of components. Once all indices are marked with their respective titles, the hostname of the master node is acquired, which is needed to be passed into the Flask server URL. Once the hostname is appended to the Flask server URL, a loop is executed to iterate over the Index_Title followed by their values. Eventually, the Flask client is called to return the predicted timestep size.

Turning to FIG. 5D2, an example routine for preprocessing incoming data in preparation for predicting timestep size (dual porosity), in accordance with one or more embodiments, is shown.

The code of routine (540) is executed if the model is dual porosity. The C++ routine (540) may to process array data coming from a Fortran file to generate a format suitable for ingestion by the Flask server. An array named Index_Title is initialized inside the routine to store the names of the indices as it is required by Flask server. Indices 1 to 5 are used for index, step number, iteration number, changes converge, residual converge, and matbal converge, respectively. Next, a loop starting from index 6 is incremented until it reaches the number of components to record residual indices titles. Another loop is executed starting from index 6, incrementing until it reaches the number of components to record changes indices titles. Next, an array index is calculated of where the array has been used by residuals and changes in order to mark the start index of the last 5 parameters which are, maximum residuals, maximum volume, timestep size, converge, and number of components. Once all indices are marked with their respective titles, the hostname of the master node is acquired, which is needed to be passed into Flask server URL. Once the hostname is appended to the Flask server URL, a loop is executed to iterate over the Index_Title followed by their values. Eventually, the Flask client is called to return the predicted timestep size.

Turning to FIG. 5E, an example routine for starting the Flask server, in accordance with one or more embodiments, is shown. The purpose of having a Flask server is to save the time that it takes to load the machine learning packages. Without Flask, all libraries would need to be loaded with each call to the python code in order to return the new timestep size that is predicted by the package. Such loading may be time consuming and may cost significant computing resources. To avoid such cost, a Flask server is started in the master node at the beginning of the simulator run, which stays active throughout the run, waiting for any request from Numerical Solver to predict a new timestep size. Also, field name is initialized in the server side as it does not change throughout the run.

Turning to FIG. 5F, an example routine for timestep size prediction by the Flask client, in accordance with one or more embodiments, is shown. The actual timestep size prediction gets executed on the client side of Flask. The serialized machine learning model of the corresponding field gets loaded first. Next, Flask fetches the data that was received and puts it in the right format that the machine learning package will accept as an input. The fetched data is stored in an array, the array is passed to the ANN package to predict the timestep size and store it in a variable to be passed back to Numerical Solver C++ routine.

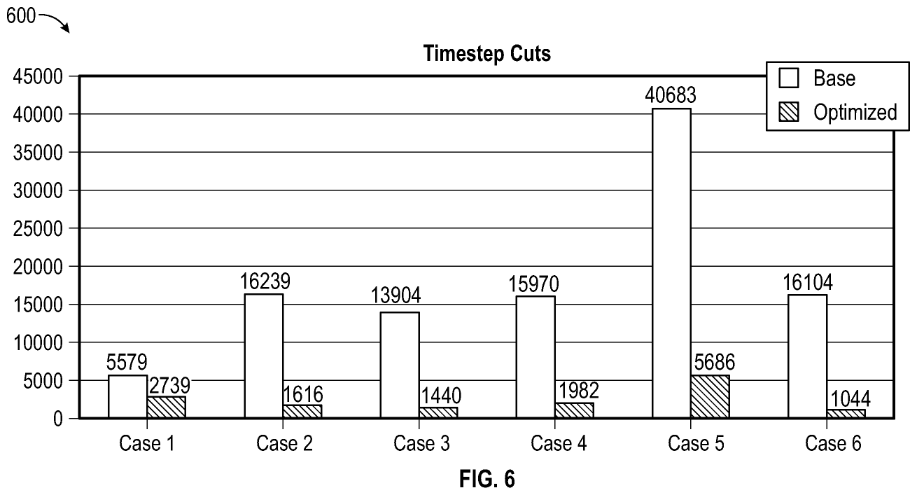

FIG. 6 shows performance results associated with implementations of embodiments of the disclosure.

Several simulation runs have been performed across a number of fields. Overall, the use of embodiments of the disclosure resulted in a speedup of up to 40% in the simulation run of some fields. The comparison was conducted by running the simulator before and after the optimization in accordance with embodiments of the disclosure. Run time was compared in both the base and optimized cases.

This speedup has been achieved due to the significant decrease in the timestep cuts that occur during the simulation as illustrated in FIG. 6, showing six examples. In the first case the result was a 21% speedup, in the second case the result was an 83% speedup, in the third case the result was a 40% speedup, in the fourth case the result was a 42% speedup, in the fifth case the result was a 39% speedup, and in the sixth case the result was a 41% speedup.

Overall, the machine learning model was able to predict the optimal timestep size with 87% accuracy. The timestep prediction accuracy has resulted in reduction of the unnecessary Newtonian iterations up to 72%.

Embodiments of the disclosure have one or more of the following benefits. Unlike previous methods, the solver may be initialized with the optimal timestep size. Accordingly, the number of timestep cuts is reduced, thereby conserving processing time and resources. Further, the timestep convergence and numerical stability are improved. Embodiments of the disclosure use a machine learning-based approach to predict the optimal timestep size. When separate machine learning models are trained for different fields, a particularly high accuracy may be achieved. The Flask Server/Client-based implementation further ensures a fast response to the simulator when calling the serialized model for prediction.

Embodiments may be implemented on a computer system. FIG. 7 is a block diagram of a computer system (702) used to provide computational functionalities associated with described algorithms, methods, functions, processes, flows, and procedures as described in the instant disclosure, according to an implementation. The illustrated computer (702) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. The illustrated computer (702) is communicably coupled with a network (730). In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702)) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or other suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704 includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), each computer (702) communicating over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

In some embodiments, the computer (702) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for accelerating numerical solution of a differential equation representing fluid flow in porous media associated with hydrocarbon well environments, the method comprising:
obtaining input data associated with a previous timestep of a numerical solver operating on the differential equation;
predicting, by a machine learning model, a current timestep size for the numerical solver from the previous timestep to a current timestep immediately following the previous timestep; and
executing the numerical solver using the current timestep size on the differential equation to generate a simulation output for the current timestep.

2. The method of claim 1, wherein the machine learning model is an artificial neural network (ANN).

3. The method of claim 2, wherein the ANN makes the prediction of the current timestep size based on at least one selected from a group consisting of a previous timestep size, pressure changes, and residual errors.

4. The method of claim 2, further comprising training the ANN.

5. The method of claim 4, wherein the training is specific to one hydrocarbon field, using training data associated with the one hydrocarbon field only.

6. The method of claim 4,
wherein the training is performed using training data for a feature set, and
wherein the training further comprises reducing the feature set to features relevant to the prediction of the current timestep size.

7. The method of claim 4, wherein the training further comprises serializing the machine learning model.

8. The method of claim 1, wherein the numerical solver uses Newton's method.

9. The method of claim 1, further comprising a preprocessing of the input data, the preprocessing comprising at least one selected from a group consisting of data smoothing and data scaling.

10. A system, comprising:
a plurality of computing systems configured to perform operations comprising:
obtaining input data associated with a previous timestep of a numerical solver operating on a differential equation;
predicting, by a machine learning model, a current timestep size for the numerical solver from the previous timestep to a current timestep immediately following the previous timestep; and
executing the numerical solver using the current timestep size on the differential equation to generate a simulation output for the current timestep.

11. The system of claim 10,
wherein a first of the plurality of computing systems is a Flask server, and
wherein a second of the plurality of computing systems is a Flask client.

12. The system of claim 11, wherein the Flask server forwards a request for the current timestep size from the numerical solver to the Flask client.

13. The system of claim 11, wherein the Flask client performs the prediction of the current timestep size.

14. The system of claim 11,
wherein a third of the plurality of computing systems executes the numerical solver.

15. The system of claim 10,
wherein the machine learning model is an artificial neural network (ANN).

16. The system of claim 15, wherein the ANN makes the prediction of the current timestep size based on at least one selected from a group consisting of a previous timestep size, pressure changes, and residual errors.

17. The system of claim 15, further comprising training the ANN.

18. The system of claim 17, wherein the training is specific to one hydrocarbon field, using training data associated with the one hydrocarbon field only.

19. The system of claim 17,
wherein the training is performed using training data for a feature set, and
wherein the training further comprises reducing the feature set to features relevant to the prediction of the current timestep size.

20. The system 17, wherein the training further comprises serializing the machine learning model.
